(19) United States
(12) Patent Application Publication
(10) Pub. No.: US 2026/0178431 A1
(43) Pub. Date: Jun. 25, 2026

(54) MEMORY MANAGEMENT METHOD AND STORAGE DEVICE

(71) Applicant: Hefei Kaimeng Technology Co., Ltd., Anhui (CN)

(72) Inventors: Zhiwei Li, Anhui (CN); Chong PENG, Anhui (CN); Xin WANG, Anhui (CN); Xuhui Cheng, Anhui (CN); Wan Jun HONG, Anhui (CN); Yang Zhang, Anhui (CN); Jian HU, Anhui (CN)

(73) Assignee: Hefei Kaimeng Technology Co., Ltd., Anhui (CN)

(21) Appl. No.: 19/386,106

(22) Filed: Nov. 11, 2025

(30) Foreign Application Priority Data
Dec. 23, 2024 (CN) 202411898460.0

(51) Int. Cl. G06F 11/07; G06F 3/06

(52) U.S. Cl. CPC G06F 11/076; G06F 3/0619; G06F 3/0653; G06F 3/0679; G06F 11/073

(57) ABSTRACT

The present invention provides a memory management method and a storage device. The method comprises: obtaining a first read count corresponding to a first physical unit in a first physical management unit; obtaining an average read count corresponding to the first physical management unit; obtaining a first evaluation value corresponding to the first physical management unit according to the first read count and the average read count, wherein the first evaluation value reflects an imbalance degree of read operations respectively performed on a plurality of physical units in the first physical management unit; and if the first evaluation value is greater than a trigger threshold, performing a read verification operation on the first physical management unit.

### CROSS-REFERENCE TO RELATED APPLICATION

This application claims the priority benefit of China application serial no. 202411898460.0, filed on Dec. 23, 2024. The entirety of the above-mentioned patent application is hereby incorporated by reference herein and made a part of this specification.

### BACKGROUND

### Technical Field

The present invention relates to the field of storage technology, and in particular to a memory management method and a storage device.

### Description of Related Art

In recent years, the rapid growth of digital cameras, mobile phones, and MP3 players has led to a sharp increase in consumer demand for storage media. Due to the non-volatility, low power consumption, compact size, lack of mechanical structure, and fast read/write speed, rewritable non-volatile memory is especially suitable for portable electronic products such as notebook computers. For example, a solid-state drive (SSD) is a memory storage device that uses high-speed memory modules as the storage medium. Accordingly, in recent years, the high-speed memory industry has become a particularly prominent sector within the electronics industry.

In general, a rewritable non-volatile memory module typically includes multiple physical erase units, and each physical erase unit comprises multiple physical programming units. When data stored in a physical programming unit of a physical erase unit is subjected to a large number of read operations (e.g., hundreds of thousands to millions of reads), the stored data may become corrupted or lost due to the applied read voltage. Moreover, such repeated read operations may also cause errors or data loss in data stored in other physical programming units within the same physical erase unit. This phenomenon is referred to as Read Disturb. Read Disturb is a phenomenon that may compromise the integrity of data stored in memory cells. When a memory cell is frequently read, the read operations may inadvertently interfere with adjacent cells, potentially causing the data stored in these cells, not being directly accessed, to change or become corrupted. Specifically, in NAND Flash structures, data is read and written at the page level, while erasing must occur at the block level. Pages are connected via word lines (WL) and are physically located adjacent to each other. When a page is subjected to repeated read operations, the floating-gate voltages of surrounding cells may be indirectly affected, leading to slight changes in the charge levels of adjacent cells. If such changes accumulate to a certain extent, the originally stored data may flip its state (e.g., from 1 to 0 or from 0 to 1), thereby causing data errors.

To address this problem, manufacturers must develop their own memory management methods to effectively suppress the likelihood of read-disturb occurrence.

### SUMMARY

The present invention provides a memory management method and storage device, which can effectively improve the accuracy of triggering a read verification operation on a physical management unit.

A memory management method for a storage device is provided according to an embodiment of the present invention. The storage device includes a memory module. The memory module includes a plurality of physical management units. The physical management units includes a first physical management unit. The first physical management unit includes a plurality of physical units. The memory management method includes the following steps. A first read count corresponding to a first physical unit among the physical units is obtained. The first read count reflects a total number of a read operation performed on the first physical unit. An average read count corresponding to the first physical management unit is obtained. The average read count reflects an average number of the read operation performed on the physical units. A first evaluation value corresponding to the first physical management unit is obtained according to the first read count and the average read count. The first evaluation value reflects an imbalance degree of the read operation performed on each of the physical units. If the first evaluation value is greater than a trigger threshold, a read verification operation is performed on the first physical management unit.

A storage device is provided according to an embodiment of the present invention. The storage device includes a connection interface, a memory module and a memory controller. The connection interface is configured to connect to a host system. The memory controller is connected to the connection interface and the memory module. The memory module comprises a plurality of physical management units. The physical management units comprises a first physical management unit. The first physical management unit comprises a plurality of physical units. The memory controller is configured to: obtain a first read count corresponding to a first physical unit among the physical units, wherein the first read count reflects a total number of a read operation performed on the first physical unit; obtain an average read count corresponding to the first physical management unit, wherein the average read count reflects an average number of the read operation performed on the physical units; obtain a first evaluation value corresponding to the first physical management unit according to the first read count and the average read count, wherein the first evaluation value reflects an imbalance degree of the read operation performed on each of the physical units; and if the first evaluation value is greater than a trigger threshold, perform a read verification operation on the first physical management unit.

Based on the above, the first read count of the first physical unit in the first physical management unit and the average read count of the first physical management unit can be obtained. In particular, first read count may reflect the total number of read operation(s) performed on the first physical unit, and the average read count may reflect the average number read operations performed on multiple physical units in the first physical management unit. According to the first read count and the average read count, the first evaluation value corresponding to the first physical management unit can be obtained. In particular, the first evaluation value can reflect the imbalance degree of read operations executed on multiple physical units in the first physical management unit. If the first evaluation value is greater than the trigger threshold, the read verification operation can be performed on the first physical management unit. Thus, the accuracy of triggering the read verification operation on the physical management unit can be effectively improved.

In particular, for certain situations that are traditionally difficult to detect, such as when only a small number of physical units within a physical management unit have severe read disturb issues, the present invention can still accurately trigger read verification operations for these physical management units

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram of a data storage system according to an embodiment of the present invention.

FIG. 2 is a schematic diagram of a memory controller according to an embodiment of the present invention.

FIG. 3 is a schematic diagram of managing memory module according to an embodiment of the present invention.

FIG. 4 is a schematic diagram showing managing physical units through physical management unit according to an embodiment of the present invention.

FIG. 5 is a flowchart of a memory management method according to an embodiment of the present invention.

### DESCRIPTION OF THE EMBODIMENTS

Reference will now be made in detail to exemplary embodiments of the present invention, examples of which are illustrated in the accompanying drawings. Wherever possible, the same reference numbers are used in the drawings and the description to refer to the same or like parts.

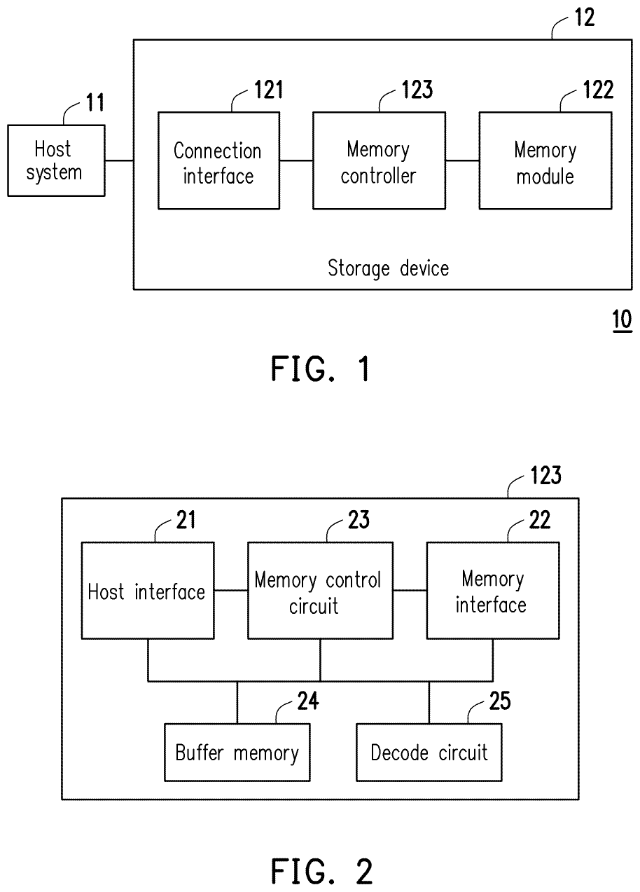

FIG. 1 is a schematic diagram of a data storage system according to an embodiment of the present invention. Referring to FIG. 1, data storage system 10 includes a host system 11 and a storage device 12. The storage device 12 may be connected to the host system 11 and configured to store data from the host system 11. For example, the host system 11 may be a smartphone, a tablet computer, a notebook computer, a desktop computer, an industrial computer, a game console, a server, or a computer system installed in a specific carrier (such as a vehicle, aircraft, or ship), and the type of the host system 11 is not limited thereto. In addition, the storage device 12 may include a solid-state drive, a USB flash drive, a memory card, or other types of non-volatile storage devices.

The storage device 12 includes a connection interface 121, a memory module 122 and a memory controller 123. The connection interface 121 is configured to connect the storage device 12 to the host system 11. For example, the connection interface 121 may support an embedded Multi-Media Card (eMMC), Universal Flash Storage (UFS), Peripheral Component Interconnect Express (PCI Express), Non-Volatile Memory Express (NVM express), Serial Advanced Technology Attachment (SATA), Universal Serial Bus (USB), or other types of connection interface standards. Thus, the storage device 12 may communicate (e.g., exchange signals, instructions, and/or data) with the host system 11 via the connection interface 121.

The memory module 122 is configured to store data. For example, the memory module 122 may include one or more rewritable non-volatile memory modules. Each rewritable non-volatile memory module may include one or more memory cell arrays. The memory cell in the memory cell arrays stores data in the form of voltage (also referred to as threshold voltage). For example, the memory module 122 may include a single-level memory cell (SLC) NAND-type flash memory module, a multi-level memory cell (MLC) NAND-type flash memory module, a triple-level memory cell (TLC) NAND-type flash memory module, a quad-level memory cell (QLC) NAND-type flash memory module, and/or other memory modules having the same or similar characteristics.

The memory controller 123 is connected to the connection interface 121 and the memory module 122. The memory controller 123 can be regarded as a control core of the storage device 12 and is configured to control the storage device 12. For example, the memory controller 123 may be configured to control or manage the entire or partial operation of the storage device 12. For example, the memory controller 123 may include a central processing unit (CPU), or other programmable general-purpose or special-purpose microprocessor, digital signal processor (DSP), programmable controller, application specific integrated circuits (ASIC), programmable logic device (PLD), or other similar devices or a combination of these devices. In an embodiment, the memory controller 123 may include a flash memory controller.

The memory controller 123 may send a command sequence to the memory module 122 to access the memory module 122. For example, the memory controller 123 may send a write command sequence to the memory module 122 to instruct the memory module 122 to store data in a specific memory cell. For example, the memory controller 123 may send a read command sequence to the memory module 122 to instruct the memory module 122 to read data from a specific memory cell. For example, the memory controller 123 may send an erase command sequence to the memory module 122 to instruct the memory module 122 to erase data stored in a specific memory cell. In addition, the memory controller 123 may also send other types of command sequences to the memory module 122 to instruct the memory module 122 to perform other types of operations, which is not limited in the present invention. The memory module 122 may receive a command sequence from the memory controller 123 and access a memory cell within the memory module 122 according to the command sequence.

FIG. 2 is a schematic diagram of a memory controller according to an embodiment of the present invention. Please referring to FIG. 1 and FIG. 2, the memory controller 123 includes a host interface 21, a memory interface 22, and a memory control circuit 23. The host interface 21 is connected to the host system 11 through the connection interface 121 to communicate with the host system 11. The memory interface 22 is configured to connect to the memory module 122 to access the memory module 122.

The memory control circuit 23 is connected to the host interface 21 and the memory interface 22. The memory control circuit 23 may be configured to control or manage the entire or partial operation of the memory controller 123. For example, the memory control circuit 23 may communicate with the host system 11 through the host interface 21 and access the memory module 122 through the memory interface 22. For example, the memory control circuit 23 may include an embedded controller or a microcontroller. In the following embodiments, the description of the memory control circuit 23 can be equivalent to the description of the memory controller 123.

In one embodiment, the memory controller 123 may further include a buffer memory 24. The buffer memory 24 is connected to the memory control circuit 23 and is configured to cache data. For example, the buffer memory 24 may be configured to cache instructions from the host system 11, data from the host system 11, and/or data from the memory module 122.

In one embodiment, the memory controller 123 may further include a decode circuit 25. The decode circuit 25 is connected to the memory control circuit 23 and is configured to encode and decode data to ensure data accuracy. For example, decode circuit 25 may support various encoding/decoding algorithms, such as low-density parity check code (LDPC code), BCH code, Reed-Solomon code (RS code), and exclusive OR (XOR) code. In one embodiment, the memory controller 123 may further include other types of circuit modules (such as a power management circuit, etc.), which is not limited in the present invention.

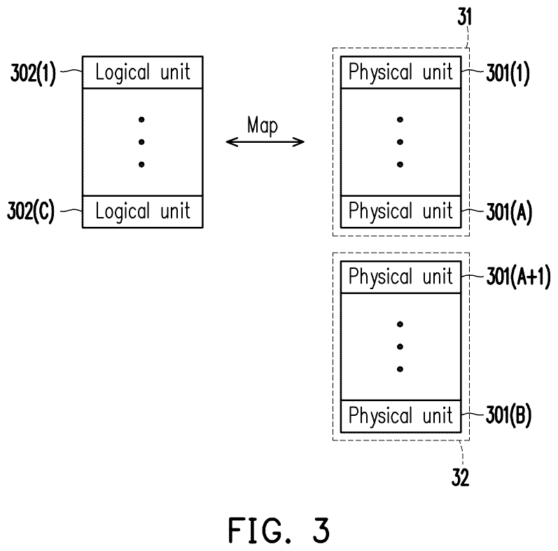

FIG. 3 is a schematic diagram of managing memory module according to an embodiment of the present invention. Please referring to FIG. 1 to FIG. 3, the memory module 122 includes a plurality of physical units 301(1) to 301(B). Each physical unit includes multiple memory cells and is configured to store data in a non-volatile manner.

In one embodiment, a physical unit may include one or more physical erasing units. In addition, a physical unit may include multiple physical sub-units. For example, a physical sub-unit may include one or more physical programming units.

In one embodiment, a physical programming unit may include multiple physical sectors. For example, the data capacity of a physical sector may be 512 bytes (B), and a physical programming unit may include 32 physical sectors. However, the data capacity of a physical sector and/or the total number of physical sectors included in one physical programming unit can be adjusted according to practical needs, and the present invention is not limited thereto. In one embodiment, a physical programming unit may be considered as a physical page. For example, the storage capacity of one physical programming unit may be 16 kilobytes (KB), but the present invention is not limited thereto.

In one embodiment, a physical programming unit is the smallest unit for synchronously writing data in the memory module 122. For example, when a programming operation (also referred to as a write operation) is performed on a physical programming unit to write data into the physical programming unit, multiple memory cells in the physical programming unit may be synchronously programmed to store corresponding data. For example, when programming a physical programming unit, write voltages may be applied to the physical programming unit to change the threshold voltage of at least a portion of the memory cells in the physical programming unit. For example, the threshold voltage of a memory cell may reflect the bit data stored in the memory cell.

In one embodiment, a physical erasing unit may include multiple physical programming units. Multiple physical programming units in one physical erasing unit can be erased simultaneously. For example, when performing an erasing operation on a physical erasing unit, erasing voltages may be applied to a plurality of physical programming units in the physical erasing unit to change the threshold voltage of at least some memory cells in the physical programming units. By performing the erasing operation on a physical erasing unit, the data stored in the physical erasing unit can be cleared (i.e., erased).

In one embodiment, the memory control circuit 23 can logically associate the physical units 301(1)-301(A) and 301(A+1)-301(B) with the data region 31 and the spare region 32, respectively. The physical units 301(1) to 301(A) in data region 31 store data from host system 11 (also referred to as user data). For example, each physical unit in the data region 31 can store valid data and/or invalid data. In addition, none of the physical units 301(A+1)-301(B) in the spare region 32 stores data (e.g., valid data).

In one embodiment, if a physical unit does not store valid data, the physical unit may be associated to the spare region 32. In addition, the physical units in the spare region 32 can be erased to clear the data in the physical units. In one embodiment, the physical units in the spare region 32 may also be referred to as spare physical units. In one embodiment, the spare region 32 may also be referred to as free pool.

In one embodiment, when data is to be stored, the memory control circuit 23 may select one or more physical units from the spare region 32 and instruct the memory module 122 to store the data in the selected physical unit(s). After storing data in the physical unit(s), the physical unit(s) can be associated to the data region 31. In other words, one or more physical units can be used alternately between the data region 31 and the spare region 32.

In one embodiment, the memory control circuit 23 may configure a plurality of logical units 302(1) to 302(C) to map the physical units (i.e., physical units 301(1) to 301(A)) in the data region 31. For example, a logical unit may correspond to a logical block address (LBA) or other logical management units. A logical unit can be mapped to one or more physical units.

In one embodiment, if a physical unit is currently mapped by any logical unit, the memory control circuit 23 may determine that the data currently stored in this physical unit includes valid data. On the contrary, if a physical unit is not currently mapped by any logical unit, the memory control circuit 23 may determine that this physical unit does not currently store any valid data.

In one embodiment, the memory control circuit 23 may record mapping relationships between the logical units and the physical units in at least one management table (also referred to as logical-to-physical mapping table). In one embodiment, the memory control circuit 23 may instruct the memory module 122 to perform operations such as data read, write, or erase according to the information in the management table (i.e., the logical-to-physical mapping table).

In one embodiment, the memory control circuit 23 may manage at least some of the physical units (e.g., physical units 301(1)-301(B)) in the memory module 122 through a plurality of physical management units. Each physical management unit can include multiple physical units. In one embodiment, a physical management unit is also referred to as a virtual unit. In one embodiment, the memory control circuit 23 may use one physical management unit as a basic unit to manage or access multiple physical units in this physical management unit. For example, multiple physical units contained in the same physical management unit can be accessed (e.g., read data, write data, or erased) synchronously or sequentially.

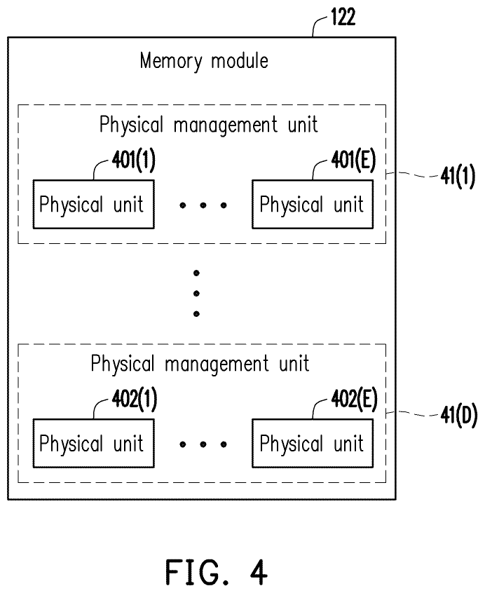

FIG. 4 is a schematic diagram showing managing physical units through physical management unit according to an embodiment of the present invention. Please referring to FIG. 4, in one embodiment, the memory module 122 includes physical management units 41(1) to 41(D). The total number of the physical management units 41(1)-41(D) can be set or adjusted according to practical needs, and the present invention is not limited thereto.

Each physical management unit in the physical management units 41(1)-41(D) may include multiple physical units. For example, the physical management unit 41(1) may include physical units 401(1) to 401(E), and the physical management unit 41(D) may include physical units 402(1) to 402(E). For example, the physical units 401(1)-401(E) and 402(1)-402(E) may be included in physical units 301(1)-301(B) in FIG. 3. In addition, the total number of physical units included in each physical management unit can be set or adjusted according to practical needs, and the present invention is not limited thereto.

In one embodiment, the memory control circuit 23 may select a physical management unit (also referred to as first physical management unit) from the physical management units 41(1) to 41(D). For example, the first physical management unit may be physical management unit 41(i), where i is an integer between 1 and D. Then, the memory control circuit 23 may determine (e.g., select) a physical unit (also referred to as the first physical unit) from the first physical management unit. The first physical unit can be one of the multiple physical units included in the first physical management unit. For example, assuming that the first physical management unit is physical management unit 41(1), then the first physical unit can be one of the physical units 401(1) to 401(E). Alternatively, assuming that the first physical management unit is the physical management unit 41(D), then the first physical unit may be one of the physical units 402(1) to 402(E).

In one embodiment, the memory control circuit 23 may determine one of the multiple physical units included in the first physical management unit as the first physical unit according to a preset rule. For example, the memory control circuit 23 may determine one of the multiple physical units included in the first physical management unit as the first physical unit at different time points by rotation or other manners.

In one embodiment, the memory control circuit 23 may perform a random algorithm to determine the first physical unit. For example, the memory control circuit 23 may randomly determine one of the multiple physical units included in the first physical management unit as the first physical unit according to a calculation result of the random algorithm. For example, the memory control circuit 23 may input a seed into the random algorithm. The random algorithm may generate an output value in response to the seed. The memory control circuit 23 may randomly determine one of the multiple physical units included in the first physical management unit as the first physical unit according to the output value.

In one embodiment, according to different output values of the random algorithm, the memory control circuit 23 may randomly determine different physical units in the first physical management unit as the first physical unit. For example, according to an output value (also referred to as first output value) of the random algorithm, the memory control circuit 23 may determine a physical unit (also referred to as first candidate unit) in the first physical management unit as the first physical unit. Alternatively, according to another output value (also referred to as second output value) of the random algorithm, the memory control circuit 23 may determine another physical unit (also referred to as second candidate unit) in the first physical management unit as the first physical unit. The first candidate unit and the second candidate unit are different physical units in the first physical management unit.

In one embodiment, after determining the first physical unit in the first physical management unit, the memory control circuit 23 may obtain a read count (also referred to as first read count) corresponding to the first physical unit. The first read count may reflect a total number of read operation(s) being performed on the first physical unit. For example, the read operation performed on the first physical unit is used to read data from the first physical unit. For example, if the total number of the read operation being performed on the first physical unit in a past time period is “40”, the first read count may be “40”. Specifically, the memory control circuit 23 may only record the latest and largest read count corresponding to the first physical unit.

In one embodiment, the memory control circuit 23 may also obtain an average read count corresponding to the first physical management unit. The average read count may reflect an average number of read operations performed on multiple physical units in the first physical management unit. For example, assuming that the average read count is “50”, this indicates that the multiple physical units within the first physical management unit have, on average, been performed “50” times of read operations during the past time period. However, in reality, a total number of read operations performed on each physical unit in the first physical management unit during the past time period may be higher or lower than the average number. Specifically, the memory control circuit 23 may only record the latest and largest read count corresponding to the first physical management unit.

Specifically, the purpose of the memory control circuit 23 recording only the latest and largest read counts corresponding to the first physical unit and the first physical management unit is to reduce the storage space required to store the read counts.

In one embodiment, the memory control circuit 23 may obtain a total read count corresponding to the first physical management unit. The total read count reflects a total number of read operation(s) performed on the first physical management unit. For example, if the total number of read operations performed on the first physical management unit in the past time period is “1000”, then the total read count may be “1000”. Then, the memory control circuit 23 may obtain the average read count according to the total read count and the total number of the physical units included in the first physical management unit. For example, assuming that the total read count is “1000” and the total number of physical units included in the first physical management unit is “20”, the memory control circuit 23 can divide the total read count (e.g., “1000”) by the total number of physical units included in the first physical management unit (e.g., “20”) to obtain the average read count (e.g., “50”).

In one embodiment, the memory control circuit 23 may obtain an evaluation value (also referred to as first evaluation value) corresponding to the first physical management unit according to the first read count and the average read count. The first evaluation value may reflect an imbalance degree of the read operation(s) performed on each of the multiple physical units in the first physical management unit. Alternatively, from another perspective, the first evaluation value may reflect whether the read operation is performed evenly on multiple physical units in the first physical management unit over a period of time in the past.

In one embodiment, the memory control circuit 23 may compare the first evaluation value with a threshold value (also referred to as trigger threshold). If the first evaluation value is greater than the trigger threshold, the memory control circuit 23 may perform a read verification operation on the first physical management unit. For example, in a case where the first evaluation value is greater than the trigger threshold (or in response to the first evaluation value being greater than the trigger threshold), the memory control circuit 23 may perform the read verification operation on all physical units in the first physical management unit one by one. For example, the read verification operation may be used to ensure or improve the accuracy of at least a portion of data currently stored in the first physical management unit. However, if the first evaluation value is not greater than (e.g., less than or equal to) the trigger threshold, the memory control circuit 23 may not perform the read verification operation on the first physical management unit. This can avoid unnecessary waste of system resources.

In one embodiment, the memory control circuit 23 may obtain an evaluation factor (also referred to as balance evaluation factor) according to the first read count and the average read count. The balance evaluation factor is related to the imbalance degree of the read operation(s) performed on each of the multiple physical units in the first physical management unit. For example, the balance evaluation factor may be positively correlated to the imbalance degree of the read operation(s) performed on each of the plurality of physical units in the first physical management unit. That is, the larger the balance evaluation factor, the higher the degree of imbalance in the read operations performed on the multiple physical units within the first physical management unit over a certain period of time (i.e., the multiple physical units within the first physical management unit have been read in a less balanced manner during that past time period). Conversely, the smaller the balance evaluation factor, the lower the degree of imbalance in the read operations performed on the multiple physical units within the first physical management unit over a certain period of time (i.e., the multiple physical units within the first physical management unit have been read in a more balanced manner during that past time period).

In one embodiment, the memory control circuit 23 may obtain the balance evaluation factor according to the following formula (1).

t=|(B(i)−AVG)/AVG| (1)

In formula (1), B(i) represents the first read count, AVG represents the average read count, and t represents the balance evaluation factor. According to formula (1), the calculated t (i.e., the balance evaluation factor) is positively correlated with the difference value (which can be positive or negative) between B(i) (i.e., the first read count) and AVG (i.e., the average read count). That is, the larger the difference value between B(i) and AVG, the larger the calculated t. It is noted that, formula (1) can also be set or adjusted according to practical needs, and the present invention is not limited thereto.

In one embodiment, after obtaining the balance evaluation factor, the memory control circuit 23 may obtain the first evaluation value according to the average read count and the balance evaluation factor. For example, the first evaluation value may be positively correlated to the average read count and the balance evaluation factor.

In one embodiment, the memory control circuit 23 may obtain the first evaluation value according to the following formula (2).

EV=AVG×(1+t) (2)

In formula (2), EV presents the first evaluation value. According to formula (2), if AVG (i.e., the average read count) and/or t (i.e., the balance evaluation factor) is larger, then the calculated EV (i.e., the first evaluation value) is also larger. It is noted that, formula (2) can also be set or adjusted according to practical needs, and the present invention is not limited thereto.

In one embodiment, if the first evaluation value is greater than the trigger threshold, it indicates that, over a certain period of time, the degree of imbalance in the read operations performed on the multiple physical units within the first physical management unit is relatively high (i.e., the differences among the respective read counts of the multiple physical units within the first physical management unit are relatively large). Accordingly, by comparing the first evaluation value with the trigger threshold, it is possible to effectively detect a physical management unit that is likely to cause access errors in the future due to an uneven degree of use among the multiple physical units within the physical management unit (for example, only some physical units suffering from severe read disturb).

On the other hand, if the first evaluation value is not greater than the trigger threshold, it indicates that, over a certain period of time, the degree of imbalance in the read operations performed on the multiple physical units within the first physical management unit is relatively low (i.e., the differences among the respective read counts of the multiple physical units within the first physical management unit are relatively small). In this case, the memory control circuit 23 may not perform the read verification operation on the first physical management unit to avoid unnecessary waste of system resources.

In one embodiment, the memory control circuit 23 may also compare the first read count with the trigger threshold. If the first read count is greater than the trigger threshold, the memory control circuit 23 may directly perform a read verification operation on the first physical management unit. For example, when the first read count is greater than the trigger threshold (or in response to the first read count being greater than the trigger threshold), the memory control circuit 23 may perform the read verification operation on all physical units in the first physical management unit one by one to ensure or improve the correctness of at least a portion of the data currently stored in the first physical management unit. However, if the first read count is not greater than (e.g., less than or equal to) the trigger threshold, the memory control circuit 23 may not perform the read verification operation on the first physical management unit to avoid unnecessary waste of system resources.

In one embodiment, in the read verification operation, the memory control circuit 23 may instruct the memory module 122 to read data (also referred to as first data) from the first physical management unit. For example, the first data may include data read from at least one physical unit in the first physical management unit.

In one embodiment, the step of reading data from at least one physical unit in the first physical management unit includes an operation of selecting a target physical unit from the first physical management unit. Specifically, the memory control circuit 23 may select a physical unit with the largest number of erase count from the first physical management unit as the target physical unit.

In one embodiment, after selecting the physical unit with the largest number of erase count as the target physical unit, all physical programming units in the physical unit are accessed to read data.

In one embodiment, not all of the physical programmable units in the selected physical unit are accessed for data reading, since such an approach is relatively time-consuming. Instead, after selecting the target physical unit, at least two physical programming units are randomly selected from the target physical unit, wherein the two physical programming units belong to adjacent word lines (WLs). For example, a first physical programming unit belongs to WL0, and a second physical programming unit belongs to WL1; and WL0 and WL1 are adjacent word lines. In addition, a first read voltage used to read data in the first physical programming unit and a second read voltage used to read data in the second physical programming unit are the same. In one embodiment, the first read voltage and the second read voltage are stored in a retry voltage table that is pre-stored into the storage device 12.

In one embodiment, said at least two physical programming units are randomly selected from the target physical unit, that is, the first physical programming unit is randomly selected, and the second physical programming unit of the adjacent word line is also randomly selected.

In one embodiment, the operation of selecting at least two physical programming units from the target physical unit is not random. Instead, the process first reads a physical programming unit having the largest physical address value. If that physical programming unit is not the target physical programming unit, then the physical programming unit corresponding to one-half of the maximum physical address value is selected for determination as to whether it is the target physical programming unit. If not, the determination is repeated by selecting another physical programming unit corresponding to one-half of the preceding value for the next round of determination. For example, if a physical unit includes 100 physical programming units, the first round searches for the physical programming unit on page 99; if the target physical unit is not got, the second round searches is performed for the physical programming unit on page 49, and so on. If the target physical programming unit is page 24, only three rounds of searching are needed to find the target physical programming unit, which is faster than traversing all the page to find the target physical programming unit.

In one embodiment, the memory control circuit 23 constructs a table related to physical programming units that have been successfully read data therefrom in response to data read commands, and manages the table using a sorting algorithm. In this table, the physical address value of the physical programming unit having the largest number of data error bits in historical read operations is arranged at the head of the table, and subsequent selections of target physical programming units can be made based on this table.

In one embodiment, the memory control circuit 23 may construct said table related to physical programming units that have been successfully read data therefrom according to the detected error bit number corresponding to at least one physical programming unit during historical read operations. For example, said table may be constructed using an LRU-K algorithm or other algorithms. For example, the memory control circuit 23 may add the physical address of the physical programming units whose error bit number are greater than the threshold value into that table. For example, the error bit number corresponding to one physical programming unit may be positively correlated to bit error rate of this physical programming unit. Thereafter, the memory control circuit 23 may select a target physical programming unit from that table, such that the error bit number corresponding to the selected target physical programming unit is necessarily greater than the threshold value.

In one embodiment, after obtaining the first data, the memory control circuit 23 may determine whether the first data meets an update condition. If the first data meets the update condition, the memory control circuit 23 may restore the first data to another physical management unit (also referred to as second physical management unit) in the memory module 122. Taking FIG. 4 as an example, assuming that the first physical management unit is the physical management unit 41(i), then the second physical management unit may be physical management unit 41(j), wherein i and j can be integers between 1 and D respectively, and i is different from j. However, if the first data does not meet the update condition, the memory control circuit 23 may not restore the first data to the second physical management unit.

In one embodiment, after obtaining the first data, the decode circuit 25 may perform a decode operation on the first data. This decode operation can be configured to detect and attempt to correct the error bit(s) in the first data. According to a result of the decode operation, the memory control circuit 23 can determine whether the total number of error bit(s) in the first data is greater than a preset value. If the total number of the error bit(s) is greater than a preset value, the memory control circuit 23 may determine that the first data meets the update condition. However, if the total number of the error bit(s) is not greater than the preset value, the memory control circuit 23 may determine that the first data does not meet the update condition.

In one embodiment, by restoring the first data originally containing relatively more error bits to the second physical management unit, the correctness of the restored first data can be improved. On the other hand, restoring the first data to the second physical management unit can also reduce the total number of error bits included in the first data subsequently read from the second physical management unit.

In one embodiment, after performing the decode operation on the first data, the memory control circuit 23 may determine whether the first data is successfully decoded according to the result of the decode operation. If the first data is be successfully decoded (e.g., the first data includes uncorrectable data or error bits), the memory control circuit 23 may determine that the first data meets the update condition. However, if the first data is successfully decoded (e.g., all data or error bits in the first data can be corrected), the memory control circuit 23 can determine that the first data does not meet the update condition.

In one embodiment, after restoring the first data to the second physical management unit, the memory control circuit 23 may reset read count information corresponding to the first physical management unit. For example, the read count information may include the total read count and/or the average read count corresponding to the first physical management unit. In one embodiment, the read count information may include read count corresponding to any physical unit in the first physical management unit. In one embodiment, in response to restoring the first data to the second physical management unit, the memory control circuit 23 may reset the total read count corresponding to the first physical management unit, the average read count corresponding to the first physical management unit, and/or the read count corresponding to any physical unit in the first physical management unit to zero (or restore it to an initial value).

In one embodiment, after restoring the first data to the second physical management unit, the memory control circuit 23 may further re-associate the first physical management unit (including all physical units in the first physical management unit) to the spare region 32 of FIG. 3. In one embodiment, after restoring the first data to the second physical management unit, the memory control circuit 23 may erase all physical units in the first physical management unit.

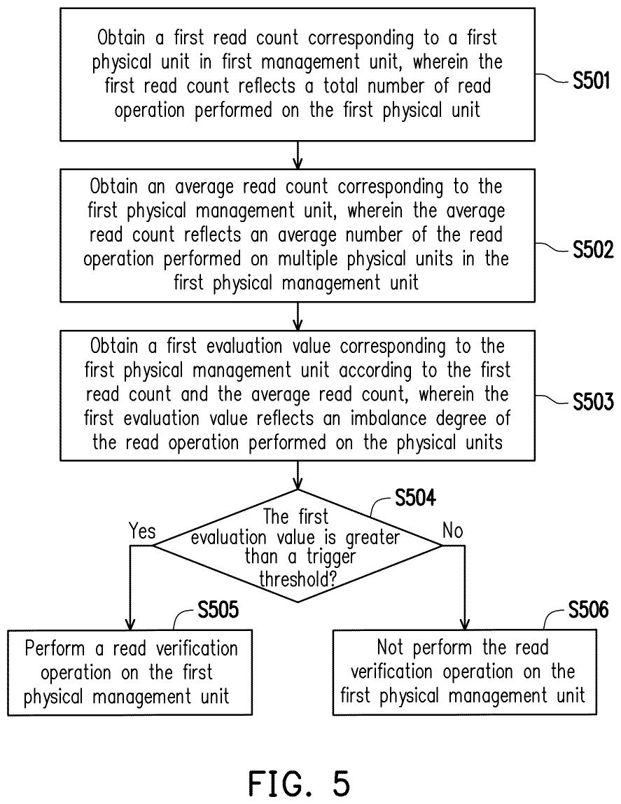

FIG. 5 is a flowchart of a memory management method according to an embodiment of the present invention. Please referring to FIG. 5, in step S501, a first read count corresponding to a first physical unit in a first physical management unit is obtained, wherein the first read count reflects a total number of read operation being performed on the first physical unit. In step S502, an average read count corresponding to the first physical management unit is obtained, wherein the average read count reflects the average number of read operations being performed on multiple physical units in the first physical management unit. In step S503, a first evaluation value corresponding to the first physical management unit is obtained according to the first read count and the average read count, wherein the first evaluation value reflects the imbalance degree of the read operations executed on the physical units. In step S504, it is determined whether the first evaluation value is greater than the trigger threshold. If the first evaluation value is greater than the trigger threshold, in step S505, a read verification operation is performed on the first physical management unit. However, if the first evaluation value is not greater than the trigger threshold, in step S506, the read verification operation is not performed on the first physical management unit.

However, each step in FIG. 5 has been described in detail above and will not be repeated here. It should be noted that each step in FIG. 5 can be implemented as multiple program codes or circuits, and the present invention is not limited thereto. In addition, the method of FIG. 5 can be used in conjunction with the above exemplary embodiments or can be used alone, and the present invention is not limited thereto.

In summary, the memory management method and storage device provided in the embodiments of the present invention can effectively improve the accuracy of triggering a read verification operation on a physical management unit. In particular, for certain situations that are traditionally difficult to detect, such as when only a small number of physical units within a physical management unit have severe read disturb issues, the present invention can still accurately trigger read verification operations for these physical management units. This can effectively improve the operational stability of the storage device.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A memory management method for a storage device, wherein the storage device comprises a memory module, the memory module comprises a plurality of physical management units, the physical management units comprise a first physical management unit, the first physical management unit comprises a plurality of physical units, and the memory management method comprises:
obtaining a first read count corresponding to a first physical unit among the physical units, wherein the first read count reflects the total number of a read operation performed on the first physical unit;
obtaining an average read count corresponding to the first physical management unit, wherein the average read count reflects an average number of the read operations performed on the physical units;
obtaining a first evaluation value corresponding to the first physical management unit according to the first read count and the average read count, wherein the first evaluation value reflects an imbalance degree of the read operation performed on each of the physical units; and
if the first evaluation value is greater than a trigger threshold, performing a read verification operation on the first physical management unit.

2. The memory management method according to claim 1, further comprising:
if the first read count is greater than the trigger threshold, performing the read verification operation on the first physical management unit.

3. The memory management method according to claim 1, further comprising:
determining, randomly, one of the physical units as the first physical unit according to a calculation result of a random algorithm.

4. The memory management method according to claim 1, wherein the step of obtaining the first evaluation value corresponding to the first physical management unit according to the first read count and the average read count comprises:
obtaining a balance evaluation factor according to the first read count and the average read count, wherein the balance evaluation factor is positively correlated with the imbalance degree; and
obtaining the first evaluation value according to the average read count and the balance evaluation factor.

5. The memory management method according to claim 4, wherein the step of obtaining the balance evaluation factor according to the first read count and the average read count comprises:
obtaining the balance evaluation factor according to the following formula:
t=|(B(i)−AVG)/AVG|

wherein B(i) represents the first read count, AVG represents the average read count, and t represents the balance evaluation factor.

6. The memory management method according to claim 1, wherein the read verification operation comprises:
reading first data from the first physical management unit;
determining whether the first data meets an update condition; and
if the first data meets the update condition, restoring the first data to a second physical management unit among the physical management units.

7. The memory management method according to claim 6, wherein the first data comprises data read from at least one of the physical units.

8. The memory management method according to claim 6, wherein the step of determining whether the first data meets the update condition comprises:
performing a decode operation on the first data;
determining whether the total number of error bits in the first data is greater than a preset value according to the result of the decode operation; and
if the total number of the error bit is greater than the preset value, determining that the first data meets the update condition.

9. The memory management method according to claim 6, wherein the step of determining whether the first data meets the update condition comprises:
performing a decode operation on the first data;
determining whether the first data is successfully decoded according to a result of the decode operation; and
if the first data is not successfully decoded, determining that the first data meets the update condition.

10. The memory management method according to claim 6, further comprising:
after the first data is restored to the second physical management unit, resetting read count information corresponding to the first physical management unit.

11. A storage device, comprising:
a connection interface, configured to connect to a host system;
a memory module; and
a memory controller, connected to the connection interface and the memory module,
wherein the memory module comprises a plurality of physical management units, the physical management units comprises a first physical management unit, the first physical management unit comprises a plurality of physical units, and the memory controller is configured to:
obtain a first read count corresponding to a first physical unit among the physical units, wherein the first read count reflects the total number of a read operation performed on the first physical unit;
obtain an average read count corresponding to the first physical management unit, wherein the average read count reflects an average number of the read operations performed on the physical units;
obtain a first evaluation value corresponding to the first physical management unit according to the first read count and the average read count, wherein the first evaluation value reflects an imbalance degree of the read operation performed on each of the physical units; and
if the first evaluation value is greater than a trigger threshold, perform a read verification operation on the first physical management unit.

12. The storage device according to claim 11, wherein the memory controller is further configured to:
if the first read count is greater than the trigger threshold, perform the read verification operation on the first physical management unit.

13. The storage device according to claim 11, wherein the memory controller is further configured to:
determine, randomly, one of the physical units as the first physical unit according to a calculation result of a random algorithm.

14. The storage device according to claim 11, wherein the operation of obtaining the first evaluation value corresponding to the first physical management unit according to the first read count and the average read count by the memory controller comprises:
obtaining a balance evaluation factor according to the first read count and the average read count, wherein the balance evaluation factor is positively correlated with the imbalance degree; and
obtaining the first evaluation value according to the average read count and the balance evaluation factor.

15. The storage device according to claim 14, wherein the operation of obtaining the balance evaluation factor according to the first read count and the average read count by the memory controller comprises:
obtaining the balance evaluation factor according to the following formula:
t=|(B(i)−AVG)/AVG|

wherein B(i) represents the first read count, AVG represents the average read count, and t represents the balance evaluation factor.

16. The storage device according to claim 11, wherein the read verification operation comprises:
reading first data from the first physical management unit;
determining whether the first data meets an update condition; and
if the first data meets the update condition, restoring the first data to a second physical management unit among the physical management units.

17. The storage device according to claim 16, wherein the first data comprises data read from at least one of the physical units.

18. The storage device according to claim 16, wherein the operation of determining whether the first data meets the update condition by the memory controller comprises:
performing a decode operation on the first data;
determining whether the total number of error bits in the first data is greater than a preset value according to the result of the decode operation; and
if the total number of the error bit is greater than the preset value, determining that the first data meets the update condition.

19. The storage device according to claim 16, wherein the operation of determining whether the first data meets the update condition by the memory controller comprises:
performing a decode operation on the first data;
determining whether the first data is successfully decoded according to the result of the decode operation; and
if the first data is not successfully decoded, determining that the first data meets the update condition.

20. The storage device according to claim 16, wherein the memory controller is further configured to:
after the first data is restored to the second physical management unit, reset read count information corresponding to the first physical management unit.
